(19) United States
(12) Patent Application Publication
(10) Pub. No.: US 2023/0065240 A1
(43) Pub. Date: Mar. 2, 2023

(54) METHOD AND APPARATUS FOR THE DISPLAY OF VOLUMETRIC SOLIDS USING DISTRIBUTED PHOTOCHROMIC COMPOUNDS

(71) Applicant: The United States of America As Represented By The Director Of The National Geospatial-Intelligence, Springfield, VA (US)

(72) Inventor: Troy White, Ashburn, VA (US)

(73) Assignee: The United States of America As Represented By The Director Of The National Geospatial-Intelligence, Springfield, VA (US)

(21) Appl. No.: 17/411,119

(22) Filed: Aug. 25, 2021

(51) Int. Cl. H04N 13/388; G02F 1/01; H04N 13/365

(52) U.S. Cl. CPC H04N 13/388; G02F 1/0126; H04N 13/365

(57) ABSTRACT

A device and methods for displaying representations of objects, solids, and surfaces volumetrically in a medium containing one or more photochromic compounds comprising at least one UVA light source arranged to project a beam of UVA radiation and irradiate at least one portion of a display volume incorporating at least one display medium which includes at least one photochromic compound. The irradiance of the irradiated portion of the display medium being sufficient for clear-to-colored transitions of voxels of the display medium from a transparent state to a colored state. After a time period after the irradiation, the irradiated voxels activated in the colored state transition by a colored-to-clear transition into the transparent state.

### FIELD OF INVENTION

Current invention is generally directed at representing and displaying representations of objects and surfaces volumetrically. The displayed content may be characterized by light of particular color or combinations of such. In addition, the representations may be stable over predetermined periods of time, thus projecting the notion of stationary 3D objects or surfaces, or may be arranged to evolve in time, potentially creating impressions of motion or other manners of continuous or stepwise changes or evolutions.

More particularly, the present invention pertains to methods and devices for displaying virtual volumetric solids and surfaces through the controlled subsurface focusing of ultraviolet A (UVA) radiation (for the purposes of the current application a functional UVA radiation range have been defined to include radiation having the wavelength ranging from 300 nm to 420 nm) upon UVA-sensitive photochromic compounds suspended, dissolved, or otherwise embedded in a transparent solid or liquid medium (referred to as a “display matrix” or “display matrices” for the purposes of the present application.) In the embodiments of the present application, the formation of the virtual volumetric solids within the display matrix may be accomplished by projecting UVA images of the desired virtual solid or surface from various aspects (sides) via projector through boundary surfaces of the display matrix by means of optical elements. The projected UVA radiation may result in the volumetric representation of the virtual solid or surface.

### BACKGROUND

Unless otherwise indicated herein, the recitations disclosed in this section are not considered to be prior art to the claims in this application and are not admitted being prior art by inclusion in this section.

In different embodiments, UVA radiation may be directed at plurality of volumetric (3D) pixels known as “voxels” of specific embodiments which may contain photochromic compounds within the display matrix via pulsed UVA lasers to create images. Volumetric displays based on the UVA irradiation methods above may be used in many fields, including, but not limited to medicine, physics, mathematics, engineering, earth sciences, etc. In some embodiments of the current application, purposely constructed and arranged displays may be utilizes to show dynamic (moving) and/or time-evolving virtual solids and surfaces.

Volumetric displays have been known in various forms. Many are based on stereoscopic optics or laser hologram technology. A relative minority have been based on the activation of photochromic compounds within a transparent medium. Some of such have been limited in their resolution and ability to represent complex objects. Modern fabrication techniques, like additive manufacturing (3D printing), have expanded volumetric display options by introducing new ways to produce optically transparent solids.

Various pigments, including those containing photochromic compounds, may be added directly to transparent solids during the printing process. In addition, specialized projectors have been developed to project images in UVA wavelengths. Such projectors known to be used with UV-curable resins for 3D printing may be used to activate UVA-sensitive photochromic compounds. The combination of printed display matrices and ultraviolet projection may enable the creation and utilization of new devices capable of displaying colored virtual solids in precise and controlled ways. The present invention addresses methods by which photochromic compounds in a display matrix can be irradiated with UVA radiation to create colored volumetric images.

Careful investigations and several experiments demonstrated that isolating photochromic compounds with characteristics suitable for the display embodied by the present invention require consistent preparation and precise control of process conditions. One of the challenges pertains to accurate determination of UVA radiation threshold energies required to initiate photochromic response in the compound samples; that is, the energy limits needed to cause an irradiated sample volume to transition from a transparent state to a colored state. The time needed for an activated (‘colored’) photochromic compound to return to its transparent state (its ‘bleaching’ rate) after UVA irradiation ceases is similarly significant.

Many commercially available photochromic compounds have been known by various product names or general and/or descriptive organic chemistry classifications only, while precise chemical formulations and structures have been proprietary and therefore not readily available. Thus, the activation energies and bleaching rates as used below may be sensitive to changes in “batch-to-batch” variations of properties of commercially available compounds. The efficacy and functionality of the embodiments of present invention rests on the assumption that activation threshold energies and bleaching rates, as described above, can be quantified, and remains substantially uniform and stable for the duration of time pertinent for the process utilization.

### SUMMARY OF THE INVENTION

A device for displaying representations of objects, solids, and surfaces volumetrically in a medium containing one or more photochromic compounds comprising having at least one UVA light source arranged to project a beam of UVA radiation and irradiate one portion of a display volume incorporating at least one display medium which includes at least one photochromic compound. The irradiance of the irradiated portion of the display medium have been sufficient for clear-to-colored transitions of voxels of the display medium to occur. After a predetermined time period after the irradiation, the irradiated voxels activated in the colored state spontaneously transitions by a colored-to-clear transition back into the original transparent state.

### BRIEF DESCRIPTION OF THE DRAWINGS

The above and other embodiments, features, and aspects of the present invention are considered in more detail in relation to the following description of embodiments shown in the accompanying drawings, in which:

FIG. 1 is a schematic representation of the device in accordance with the current invention.

FIG. 2 is a schematic representation of some elements of the device in accordance with the current invention.

FIG. 3 is a schematic representation of additional elements of the device in accordance with the current invention.

FIG. 4 is a schematic representation of other additional elements of the device in accordance with the current invention.

FIG. 5 is a schematic representation of an embodiment of the device in accordance with the current invention.

FIG. 6 is a schematic representation of another embodiment of the device in accordance with the current invention.

FIG. 7 is a schematic representation of yet another embodiment of the device in accordance with the current invention.

FIG. 8 is a schematic representation of yet another embodiment of the device in accordance with the current invention.

FIG. 9 is a schematic representation of yet another additional elements of the device in accordance with the current invention.

### DESCRIPTION OF SEVERAL EMBODIMENTS OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

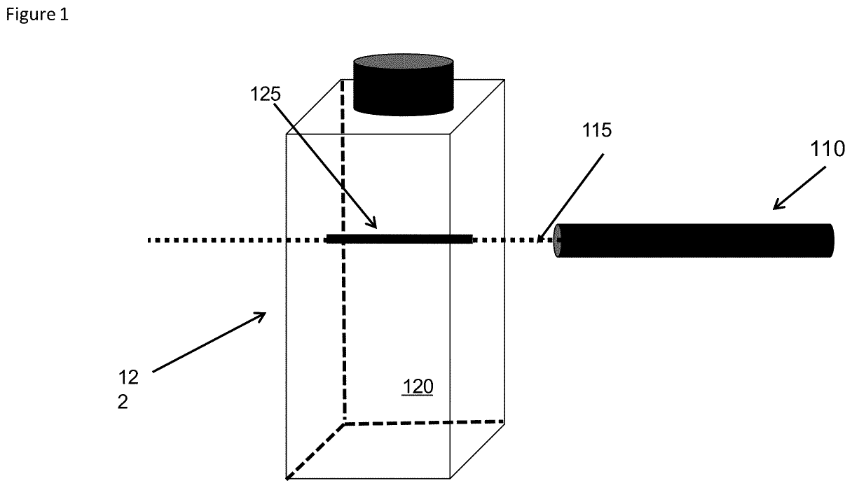

FIG. 1 illustrates embodiments conducted using Class II 405 nm lasers representing an UVA light source 110 arranged to project at least one beam of UVA radiation 115 and irradiate at least one portion of a display volume 120 in the display medium 122 incorporating at least one display medium containing at least one commercially available photochromic compound for a predetermined time. The commercially available clear-to-red photochromic compound may be (potentially diluted) household solvents (white spirits or acetone) to form solutions having different concentrations of the compound.

The volumetric surfaces 125 formed by the portions of the photochromic compounds 130 that exhibited the “clear-to-colored” state transition, have been bound to the volumes irradiated by the UVA beam of the laser. Once the light source 110 as been shut off, the dissolved compound reverted to its clear state. The duration of the “colored-to-clear” transition may be only a fraction of a second, and may vary according to the predetermined period of time of irradiation of the photochromic compound and the power setting of the laser used. In addition, compositions and conditions of the solutions of the photochromic compounds (e.g., particular choices of the compounds and solvents, proportions of ingredients in solutions, size and form of dissolved or suspended particulates, temperature, viscosity, thermal conductivity etc.) photochromic compound has been observed to influence the duration of the existence of the colored states and it subsequent transition to the (original) “clear” (i.e., transparent) state.

One may note that the UVA radiation emitted by the light source exhibit only limited range of wavelengths and may be only marginally redirected in the display volume 120. Thus, the observation of the color of the volumetric surfaces 125 may be contingent upon application of additional (directed or ambient) visible light, although, in some embodiments, additional optical phenomena (fluorescence, phosphorescence, light scattering, absorption, dispersion etc.) may contribute to the visible appearances of the volumetric surfaces 125.

A wide variety of photochromic compounds are known to practitioners. For the devices and methods of the current inventions following (nonexclusive) group of photochromic compounds has been considered and/or tested; including but not limited to: [2H]chromenes, diarylethenes, diarylnaphthopyrans, dithienylethene, derivatives, furylfulgide, derivatives, hexaarylbiimidazole, indolinospirothiapyrans, naphthopyrans, photochromic quinones, ruthenium sulfoxide compounds, silver halides, sodium nitroprusside, spirooxazines, spiropyrans, and titanium dioxide. In several embodiments, physio-chemically-compatible mixtures of the above compounds have been involved.

Each photochromic compound, naturally occurring or synthetic, is sensitive to a specific wavelength range of the UV spectrum. In addition, and each may have, dependent n the particular compositions and conditions in the display medium 122 may exhibit distinct bleaching rate (i.e., rate of “colored-to-clear” transition). For example, hexaarylbiimidazole (HABI)—included in the list above, which turns dark blue upon UVA exposure by the Class II, exhibited bleaching during 180 ms after irradiation, when combined with naphthalene. Such bleaching rates may be compatible with frame rates of a dynamic volumetric display. The bleaching rate for the cyclophane version of HABI has been observed to be much higher (substantially instantaneous), making it a good candidate for high framerate display mediums 122.

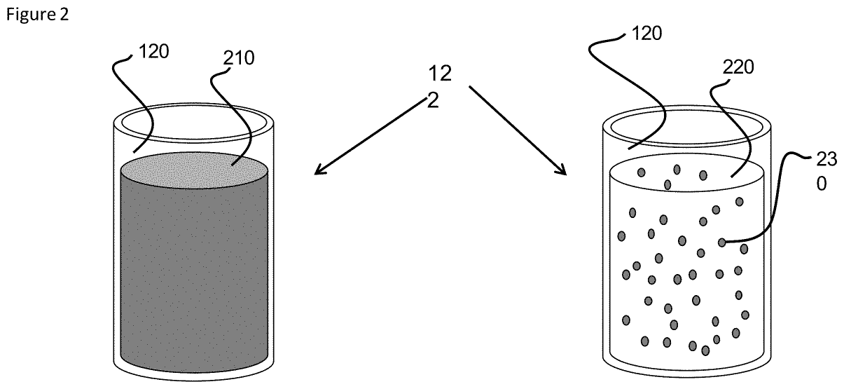

FIG. 2 pertains to the embodiments of current inventions where one or more photochromic compounds may be distributed into a liquid media 210 in the form of molecular solution of one or more photochromic compounds in a one or more compatible solvents. In many embodiments such arrangements provide desirable homogeneity and uniformity of the photochromic compounds' distribution. In addition, the contrast between the colored portions and non-colored portions may be further controlled, for example by adjusting the concentrations of the molecular solutions.

In different embodiments the photochromic compounds may be distributed in gel media 220 in the form of naturally forming or prefabricated particulates 230 incorporating concentrations of the photochromic compounds. In one embodiment, the particulates 230 may have a form of micro-balloon or layered microsphere having a transparent envelope (UVA transparent glass or transparent polymer) encapsulating desirable concentrations of the photochromic compounds. In such embodiments, adjustments of refractive indices of the encapsulating materials may be carefully considered and adjusted to minimize scattering of the UVA radiation and/or the visible light utilized for detection and observation of the colored states.

In different embodiments, the particulates 230 may be naturally aggregated in the form of molecular clusters (e.g., in the form of colloidal particles of colloidal solutions) or (micro)crystals. Several transitional embodiments that, for example, may exist in liquid phases (“sol”) or mixed condensed phases (“gel”) can also be utilized. As recited above, control of uniformity and dynamics of the optical characteristics of the media exhibiting higher viscosity may be of particular interest for optimization of display qualities of the represented 3D surfaces.

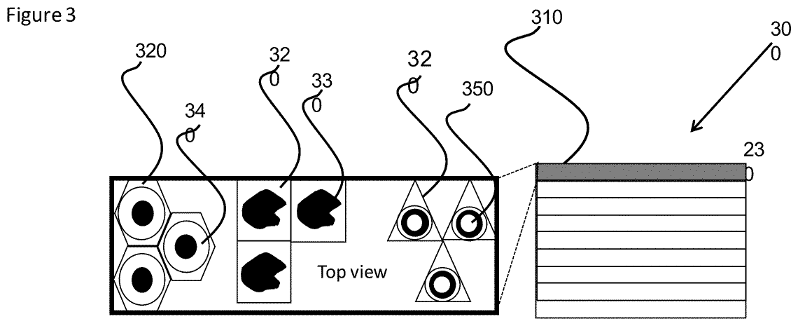

An additional family of embodiments has been illustrated schematically in FIG. 3. FIG. 3 illustrates the embodiments having photochromic compounds incorporated into a solid display matrix 300. The display medium of this family may include a plurality 3D printed grid layers 310 each incorporating at least one pattern of photochromic voxels 320 patterns containing at least one photochromic compound. In particular embodiments the photochromic compounds may be imprinted directly in the predetermined shapes 330 on a surface in the greed layer 310 in the pattern of voxels 320. In other embodiments voxels 320 may incorporate micro-balloons 340 or layered microspheres 350 composed from one or more photochromic compounds and transparent parts having matched indices of refraction.

The FIG. 3-illustrated-embodiment depicts voxels 320 having sections incorporating the photochromic compounds enabled to transition into colored states of different colors. Such arrangement may allow for broad variety of color combinations when complementary primary colors (e.g., RGB) have been preselected.

Incorporating multiple colors in a volumetric display may add to the display's design complexity. In addition, photochromic compounds with relatively low clear-to-colored transition energy thresholds may activate strongly whenever nearby higher clear-to-colored transition energy compounds are activated. Such concurrent activation may result in an oversaturation of color, clouding the display matrix 300.

One way to addresses the problem of oversaturation is the use of pulsed UVA light sources. In pertinent embodiments, multiple pulsed UVA beams, each conveying a fraction of the energy required to activate a specific photochromic compound could be directed to target a specific area in the display matrix. Such methods may be conceptually related to processes used instereotactic radiotherapy treatment of malignant cells and/or tissues. Non-targeted voxels in the path of individual UVA beams may not receive the energy to activate, but the targeted area where plurality of the beams may converge may have the combined absorbed energy of all the UVA beams sufficient to trigger and support desired clear-to-colored state transitions.

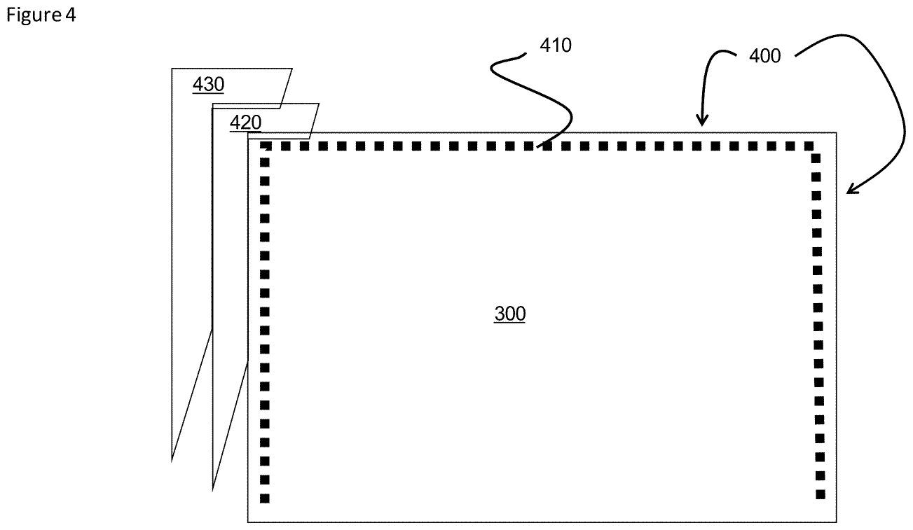

Some additional features of the above embodiments have been introduced in FIG. 4. The internal or partial reflection of UVA radiation off the interior surfaces of the solid display matrix 300 may saturate portions of the display volume with unwanted color if energetic enough to activate photochromic compounds in the display matrix 300. In the illustrated embodiment, the issue of internal reflection may be addressed by the doping of the region of the display matrix 300 nearest reflective surfaces 400 with UVA absorbing compounds 410. Desirably, such compounds may either have refractive indices approximating that of the display matrix 300 and/or be arranged not to significantly impact the transmission of visible light used for the colored states observations.

In addition, or as an alternative in some embodiments, an UVA-absorptive film 420 may be utilized to alleviate the aforementioned dysfunctionalities caused by unwanted internal reflections of the UVA radiation or UVA irradiation from external sources. In addition, such films may contribute to the protection of the external light detectors utilized to observe and/or record the color transitions.

Furthermore, additional layers 430 arranged to provide backdrop for the displayed representations of the 3D surfaces may be added in some embodiments. Asymmetric perforated one-way films may be arranged for such functionalities. The layers 430 may be used to cover the exterior the displays display matrices 300. The reflective (white) side of the film may be directed to the interior of the display matrix 300 and the absorbing (black) side to the exterior. Without such backdrop, any displayed virtual objects could become lost when viewed against a low or mixed contrast background. To avoid constructive interference of light entering the perforated film, the holes in the layer 430 may differ in size and shape and be arranged as asymmetrically as practical.

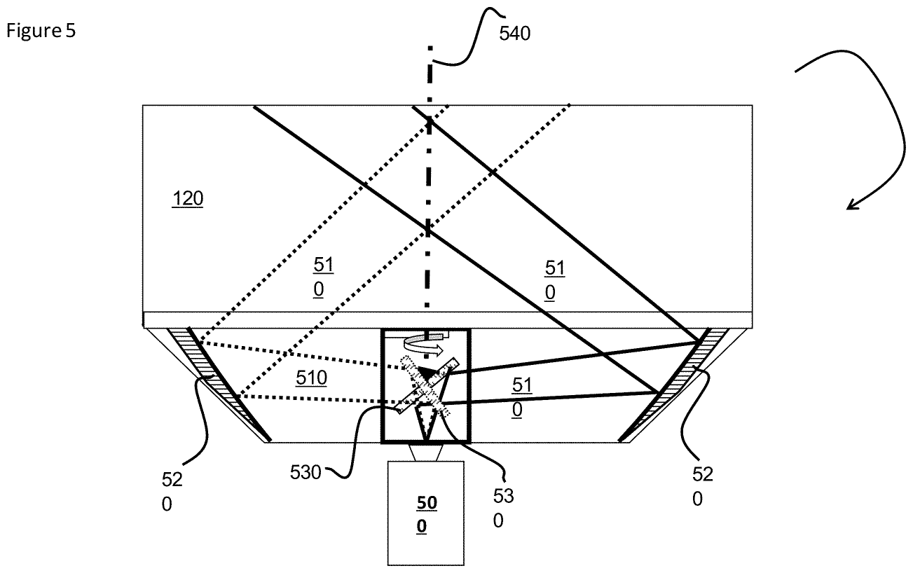

FIG. 5 illustrates yet another class of embodiments of the device for displaying representations of objects, solids, and surfaces. Devices from the illustrated class of utilize at least one UVA light source in the form of projector 500 arranged to project at least one beam 510 of UVA radiation and irradiate at least one portion of the display volume 120. The devices also include at least one axisymmetric collimating optical assembly 520, and at least one rotating mirror 530 (illustrated in two diametrically opposite positions, i.e., differing 180° in the rotational phase). The rotating mirror 530 rotates with respect to the axis of rotation 540 which also represents the axis of symmetry of the collimating optical assembly 520 arranged to project several aspects of the representations of objects into the at least one portion of a display volume 120.

In different embodiments the collimating optical assembly 520 may include sections of concave mirrors (spherical, elliptical, parabolic etc.) Also, the rotating mirror 540 may incorporate reflective surfaces exhibiting optical power (spherical, elliptical, parabolic, and/or composite) arranged, for example, to correct or optimized imaging properties of the projector 500.

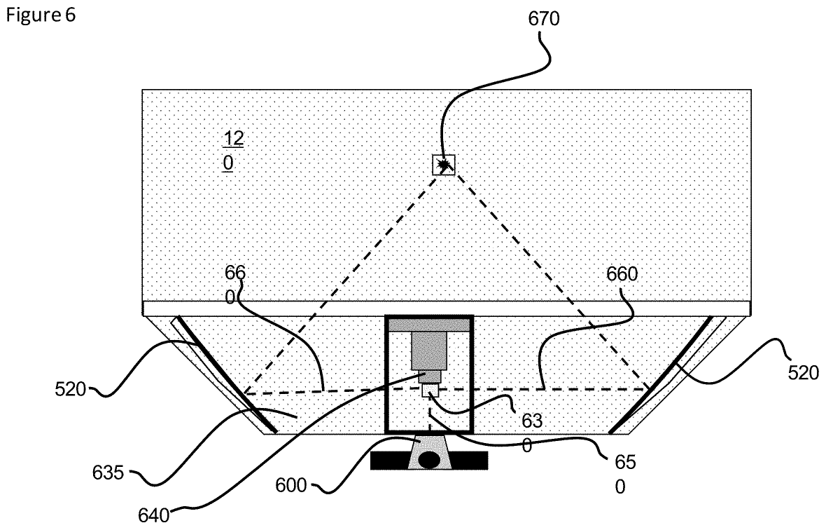

FIG. 6 illustrates yet another class of embodiments of the device for displaying representations of objects, solids, and surfaces. Devices from the illustrated class of utilize at least one pulsed UVA laser 600, at least one axisymmetric collimating optical assembly 520, and at least one rotating beam splitter 630 affixed to a telescopic gimbal mount 640 arranged for rapid multi-axis adjustment and arranged to split at least one pulsed laser beam of UVA radiation 650 into at least two resulting beams 660, and directs the resulting beams to at least one axisymmetric collimating optical assembly 520 arranged to converge the resulting UVA laser beams on at least one addressable voxel 670.

In some embodiments, the at least one rotating beam splitter 630 and the telescopic gimbal mount 640 may be immersed in a fluid 635 exhibiting a refractive index closely matching the refractive index of materials in the display volume 120.

In other embodiments, the pulsed laser 600 may radiate of multiple UVA wavelengths. In addition, the rotating beam splitter 630 may include a first-surface mirror arrangement. The mirrors in the arrangement may be angled and arranged radially about a drum (or a single mirror in the form a frustum may be used). The pulsed laser beam 600 may inject the laser beams from below the drum through an opening to the rotating beam splitter 630. The beam splitter 630, which is affixed on a telescopic mount 640 that allows for rapid vertical adjustment (for example using a voice coil solenoid or piezoelectric actuator), splits the pulsed beam and directs the resulting beams 650 to the collimating assembly first-surface mirrors mounted in a drum. The beams may converge on addressable voxels 670 with the display volume 120 at the clear-to-color transition energy causing the voxels to color. Thus, through a regressive (top-to-bottom) scan, the virtual surface or 3D solid can be formed in layers.

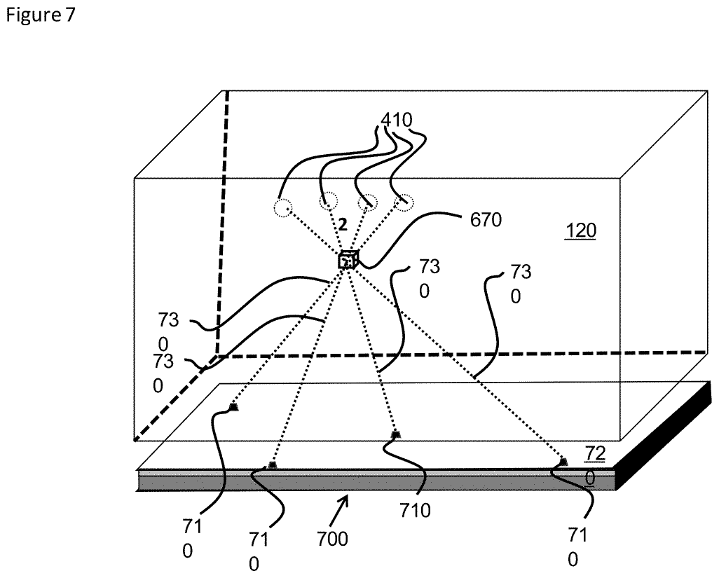

FIG. 7 illustrates yet another class of embodiments of the device in accordance with the present invention. In embodiments of this class the UVA light source arranged to project UVA radiation includes at least one pulsed UVA laser array 700 containing a plurality of sources 710 of coherent UVA light (e.g., laser diodes). In a particular embodiment the display volume 120 may be contained in a UVA transparent envelope (UV acrylic, cyclic olefin copolymer, fused silica glass or any compatible UVA-transparent material. With exception of the boundary surface 720 directly facing the UVA laser array 700, boundary surfaces of the volume 120 have been coated by the UVA absorbing compounds 410 and arranged to prevent unwanted reflections of the UVA laser beams 730.

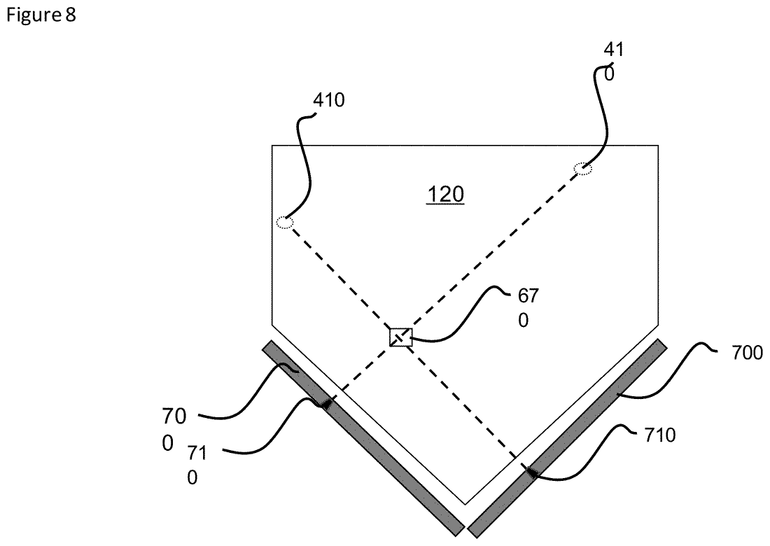

FIG. 8 illustrates yet another additional class of embodiments of the device in accordance with the present invention. The devices of such class of embodiments include at least two planar pulsed UVA laser array 700 mutually positioned at predetermined angle having at least one laser elements 710 each arranged to irradiate the at least one common addressable voxel 670 incorporating at least one photochromic compound. Combined UVA energy absorbed by the photochromic compound may be sufficient to induce at least one clear-to-colored transition inside the irradiated common addressable voxel 670.

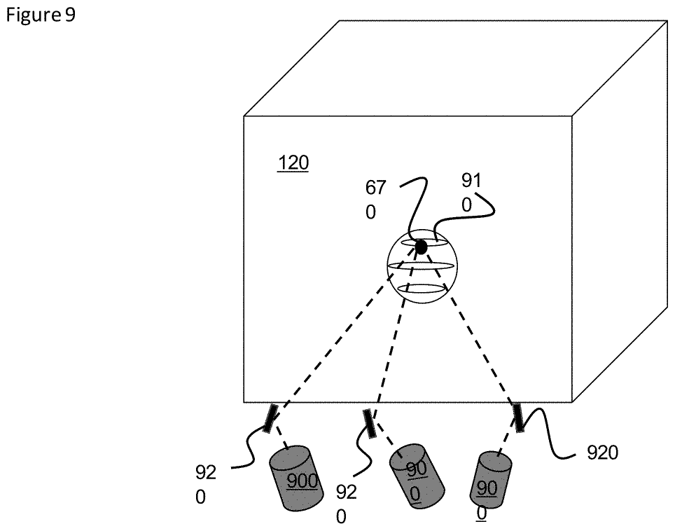

Yet another embodiment in accordance with the current invention has been illustrated in FIG. 9. In such embodiment at a plurality of UVA lasers 900 have been arranged to irradiate predetermined parts of the display volume 120 regressively, i.e., starting from the cross sections 910 proximal to surfaces opposite from the surfaces facing the UVA lasers 900. The control of the UVA laser beams may be achieved using compatible beam-directing optical subsystems incorporating numerically-controllable MOEMS mirrors or mirror arrays 920 (incorporating a plurality of MOEMS mirror array elements) arranged and oriented such that at least two of the MOEMS mirror elements irradiate at least one at least one common addressable voxel 670.

While specific values, relationships, materials, and components have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the embodiments and certain modifications of the concepts underlying the present invention, various other embodiments as well as certain variations and modifications of the embodiments herein shown and described will obviously occur to those skilled in the art upon becoming familiar with such underlying concepts. It is intended to include all such modifications, alternatives, and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A device for displaying representations of objects, solids, and surfaces volumetrically in a medium containing one or more photochromic compounds comprising:
at least one UVA light source arranged to project at least one beam of UVA radiation and irradiate at least one portion of a display volume incorporating at least one display medium containing at least one photochromic compound for a predetermined time period,
wherein, the irradiance of the irradiated portion of the at least one display medium and the predetermined time period have been sufficient for at least one clear-to-colored transition of at least one voxel of the at least one display medium from a transparent state to a colored state, and
wherein, after the predetermined time period after the irradiation, the at least one voxel activated in the colored state spontaneously transitions by a colored-to-clear transition back into the original transparent state.

2. The device of claim 1, wherein the at least one photochromic compound has been chosen from the group of photochromic compounds consisting of [2H]chromenes, diarylethenes, diarylnaphthopyrans, dithienylethene, derivatives, furylfulgide, derivatives, hexaarylbiimidazole, indolinospirothiapyrans, naphthopyrans, photochromic quinones, ruthenium sulfoxide compounds, silver halides, sodium nitroprusside, spirooxazines, spiropyrans, titanium dioxide, and its mixtures and combinations.

3. The device of claim 1, wherein the at least one photochromic compound is dissolved into at least one liquid medium.

4. The device of claim 1, wherein the at least one photochromic compound is suspended into at least one liquid medium.

5. The device of claim 1, wherein the at least one photochromic compound is dispersed into at least one gel medium.

6. The device of claim 1, wherein the at least one display medium incorporates at least one 3D printed display matrix composed of plurality of printed grid layers each incorporating at least one pattern of photochromic voxel layers containing at least one photochromic compound.

7. The device of claim 6, wherein the at least one 3D printed display matrix has been surrounded by at least one surface incorporating at least one UVA-absorbing dopant arranged to reduce at least one of:
internal reflection of the UVA radiation; or
entry and exit of the UVA radiation.

8. The device of claim 6, wherein the at least one 3D printed display matrix has been surrounded by at least one surface incorporating at least one asymmetric perforated one-way film arranged to provide background for the displayed representations of objects, solids, and surfaces.

9. The device of claim 1, wherein the at least one UVA light source comprises at least one UVA image projector, the device further comprising:
at least one axisymmetric collimating optical assembly; and
at least one rotating mirror arranged to project several aspects of the representations of objects into at least one portion of the display volume.

10. The device of claim 1, wherein the at least one UVA light source comprises at least one pulsed UVA laser, the device further comprising:
at least one rotating beam splitter affixed to at least one telescopic gimbal mount arranged to split at least one pulsed laser beam of UVA radiation into at least two resulting beams; and
at least one axisymmetric collimating optical assembly arranged to converge at least two of the at least two resulting UVA laser beams on at least one addressable voxel within at least one portion of the display volume.

11. The device of claim 1, wherein the at least one UVA light source comprises at least two planar pulsed UVA laser arrays mutually positioned at predetermined angles, the laser arrays each having at least one element arranged to irradiate at least one common addressable voxel incorporating the at least one photochromic compound such that combined UVA energy absorbed by the at least one photochromic compound drives the at least one clear-to-colored transition of the at least one at least one common addressable voxel.

12. The device of claim 10, wherein the at least one pulsed UVA laser is arranged to radiate at least one pulsed beam of UVA radiation and irradiate the at least one portion display volume forming successive cross sections of the represented 3D objects.

13. The device of claim 12, further comprising at least one mirror array field, the mirror array field comprising a plurality of MOEMS mirror elements arranged and oriented such that at least two of the MOEMS mirror elements irradiate at least one common addressable voxel of the cross section of the represented 3D object such that combined UVA energy absorbed by the at least one common addressable voxel drives the at least one clear-to-colored transition.

14. A method for displaying representations of objects, solids, and surfaces volumetrically in a medium containing one or more photochromic compounds, the method comprising projecting at least one beam of UVA light into at least one portion of a volumetric display, the volumetric display comprising at least one display medium comprising at least one photochromic compound, the at least one photochromic compound arranged to undergo a clear-to-colored transition when irradiated by the at least one beam of UVA light.

15. The method of claim 14, wherein the at least one beam of UVA light is provided by at least one pulsed UVA laser, the method further comprising:
splitting the at least one beam of UVA light into at least two resulting beams;
directing at least two of the at least two resulting beams to at least one axisymmetric collimating optical assembly; and
converging at least two of the at least two resulting beams on at least one addressable voxel for a time period sufficient to drive at least one clear-to-colored transition of the at least one addressable voxel.

16. The method of claim 14, wherein the at least one beam of UVA light is provided by at least one pulsed UVA laser array, at least two elements of the at least one pulsed UVA laser array being arranged to irradiate at least one common addressable voxel such that the UVA energy absorbed by the at least one common addressable voxel drives at least one clear-to-colored transition of the at least one common addressable voxel.

17. The method of claim 14, wherein the at least one beam of UVA light is provided by at least two planar pulsed UVA laser arrays mutually positioned at predetermined angles, each array having at least one element arranged to irradiate at least one common addressable voxel incorporating the at least one photochromic compound such that UVA energy absorbed by the at least one photochromic compound drives the at least one clear-to-colored transition of the at least one common addressable voxel.

18. The method of claim 14, wherein the at least one beam of UVA light is provided by at least one UVA image projector, the method further comprising:
projecting, by the at least one UVA image projector, at least one beam of UVA light onto at least one rotating mirror arranged to project several aspects of the representations into at least one portion of the display.

19. The method of claim 18, wherein the at least one rotating mirror comprises at least one of a spherical, elliptical, or parabolic mirror.

20. The method of claim 14, wherein the one or more photochromic compound has been chosen from the group of photochromic compounds consisting of [2H]chromenes, diarylethenes, diarylnaphthopyrans, dithienylethene, derivatives, furylfulgide, derivatives, hexaarylbiimidazole, indolinospirothiapyrans, naphthopyrans, photochromic quinones, ruthenium sulfoxide compounds, silver halides, sodium nitroprusside, spirooxazines, spiropyrans, titanium dioxide, and its mixtures and combinations.
